(19) United States
(12) Patent Application Publication
(10) Pub. No.: US 2009/0200793 A1
(43) Pub. Date: Aug. 13, 2009

(54) CROWN SEAL WITH INTEGRAL SEALING PROJECTIONS FOR UNDERSEA HYDRAULIC COUPLINGS

(75) Inventor: Robert E. Smith, III, Missouri City, TX (US)

Correspondence Address: WONG, CABELLO, LUTSCH, RUTHERFORD & BRUCCULERI,;L.L.P., 20333 SH 249 6th Floor, HOUSTON, TX, 77070, US

(73) Assignee: NATIONAL COUPLING COMPANY, INC., Stafford, TX (US)

(21) Appl. No.: 12/027,472

(22) Filed: Feb. 7, 2008

(51) Int. Cl. F16L 37/28

(52) U.S. Cl. 285/111

(57) ABSTRACT

A crown seal for sealing between the body of a female hydraulic coupling member and the probe section of male hydraulic coupling member has sealing projections on or near its outer diameter to provide enhanced sealing effectiveness between the crown seal and the body of the female member and obviate the need for circumferential O-ring seals. In a first embodiment, the sealing projections have a substantially circular cross section and project both axially and radially from the body of the crown seal. In a second embodiment, the sealing projections have a semicircular cross section and project in an axial direction from certain outside edges of the crown seal. Crown seals according to the invention may be retrofitted to female hydraulic couplings of the prior art. Alternatively, the body of the female coupling or a seal retainer or seal cartridge fitted therein may be provided with grooves or contoured surfaces to fit the sealing projections on the crown seal.

### CROSS-REFERENCE TO RELATED APPLICATIONS

NONE

### STATEMENT REGARDING FEDERALLY SPONSORED RESEARCH OR DEVELOPMENT

NOT APPLICABLE

### BACKGROUND OF THE INVENTION

1. Field of the Invention

This invention relates to hydraulic couplings for subsea use. More particularly, it relates to polymeric crown seals for sealing between the body of a female hydraulic coupling member and the probe of a male hydraulic coupling member inserted into the receiving chamber of the female member.

2. Description of the Related Art including information disclosed under 37 CFR 1.97 and 1.98.

Subsea hydraulic couplings generally consist of a male member and a female member having seals designed to seal the junction between the male and female members. The female member generally has a cylindrical body with a relatively large diameter bore at one end and a relatively small diameter bore at the other. The smaller bore facilitates connections to hydraulic lines, while the larger bore contains the seals and receives the male portion of the coupling. The male member includes a probe section insertable into the large bore of the female member. According to various embodiments of the device, the seals either abut the end, or face, of the male member or engage the male member about its outer circumference. Hydraulic fluid is then free to flow through the female and male portions of the coupling and seals prevent that flow from escaping about the joints of the coupling.

Optionally, a check valve may be installed in the female member and also in the male member. Each check valve is open when the coupling is made up; however, each check valve closes when the coupling is broken so as to prevent fluid from leaking out of the system of which the coupling is part.

In U.S. Pat. Nos. 4,694,859 and 5,762,106 to Robert E. Smith III, an undersea hydraulic coupling and metal seal are disclosed. A reusable metal seal engages the circumference of the probe when it is positioned within the female member body. The seal is held in place by a cylindrical body or retainer. When the male and female portions of the coupling are parted under pressure, the retainer prevents the metal seal from blowing out through the bore of the female member.

U.S. Pat. No. 4,900,071 to Robert E. Smith III discloses an undersea hydraulic coupling with an elastomeric seal that is restrained from radial movement into the central bore of the female member by a circumferential shoulder on one or both surfaces adjacent the seal. Preferably, the seal has a dovetail interference fit with one or both surfaces. U.S. Pat. Nos. 5,052,439, 5,099,882, 5,203,374 and 5,232,021 to Robert E. Smith III also show undersea hydraulic couplings with these seals. An inner cylindrical surface of the annular seal engages the circumference of the male member or probe as the probe is inserted into the female member. As the male member or probe is pulled out of the female member bore, the leading face of the male member reaches the soft annular seal intermediate that bore. When the face reaches the midpoint of the soft annular seal, the dovetail interference fit prevents the seal from imploding into the bore, as the seawater and/or hydraulic fluid enter the bore at high pressure.

If the probe of the male coupling member is imperfectly aligned with the female coupling member, it can drag against the female coupling bore or receiving chamber, and drag against each seal retained in the bore. The drag can result in galling of the surfaces of the respective coupling members. The drag can also damage the seals retained in the female coupling member, especially pressure-energized radial metal seals that seal around the circumference of the male coupling member.

To help align the male coupling member when it enters the female bore or receiving chamber, some undersea hydraulic couplings include two or more redundant radial seals. Two or more seals provide guide points to help the male member enter the bore or receiving chamber without galling and damage to the sealing surfaces. Additionally, two or more redundant seals reduce the risk that hydraulic fluid will leak from the coupling at higher pressures and greater undersea depths.

U.S. Pat. No. 6,575,430 to Robert E. Smith III discloses an undersea hydraulic coupling member having a ring-shaped seal with multiple sealing surfaces which extend radially inwardly into the receiving chamber of the female member. The multiple sealing surfaces help guide the probe of the male coupling member into the female member without the risk of drag or galling of the receiving chamber or metal seal retained therein. The seal has an interference fit with reverse inclined shoulders in the female member to restrain the seal from moving radially inwardly due to vacuum or low pressure such as may be produced by the withdrawal of the male probe.

The crown seal disclosed in U.S. Pat. No. 6,575,430 provides an undersea hydraulic coupling with a ring-shaped polymeric seal having two or more radial sealing surfaces at the inner circumference thereof. Each of the sealing surfaces at the inner circumference engages the probe of the male coupling member, providing guide points to help ensure proper alignment between the coupling members, prevent or reduce the risk that the male coupling member will drag against the female coupling member during engagement or disengagement, and prevent or reduce the risk of galling of the surfaces and seals retained therein.

On each side of the polymeric seal, opposing inclined circumferential shoulder surfaces have an interference fit with the seal and prevent the seal from imploding and/or radially moving into the bore especially upon separation of the female member and male member. The seal has inclined surfaces that have an interference fit with the opposing inclined shoulder surfaces.

A coupling of the prior art first disclosed in U.S. Pat. No. 6,575,430 is shown in FIG. 1. Female member 20 comprises body 21, handle 48 which may be threaded to a manifold plate, and central bore 32 which has several variations in its diameter as it extends through the female member. The first end of the bore may be internally threaded for connection to a hydraulic line. A cylindrical passageway extends longitudinally within the female member body and terminates at valve seat 27. Adjacent valve seat 27 is shoulder 33 which forms one end of receiving chamber 34.

In the illustrated coupling member, the receiving chamber (which receives the probe of the male member) has a stepped internal diameter with internal shoulders 33, 35 and 63. The receiving chamber has a first smaller diameter 34 and a second larger diameter 47.

In the illustrated coupling, the female member includes poppet valve 28 which is slidably received within the cylindrical passageway. The poppet valve is conical in shape and is urged by valve spring 41 into a seated position against valve seat 27. When the poppet valve is in a closed position against the valve seat, it seals fluid from flowing between the male member and the female member. Hollow spring collar 42 anchors the valve spring 41 and is held in place by a collar clip. Actuator 44 extends from the apex of the poppet valve. A corresponding valve actuator in the male member contacts actuator 44 to open valve 28 upon coupling makeup.

Ring shaped seal 70 is positioned in the receiving chamber of the female member. The ring shaped seal is an elastomer or polymer seal that is flexible and resilient. As shown in FIG. 2, the seal has a first inclined shoulder surface 72 and a second inclined shoulder surface 71. The axial thickness of the elastomeric seal at outer circumference 66 is greater than the axial thickness of the seal at inner circumference 73. The seal has a generally wedge-shaped cross section. The seal has at least two radial sealing surfaces 75, 76 extending inwardly from the seal's inner circumference 73. Each of the radial sealing surfaces extends radially inwardly from the inner circumference to engage the probe of the male member when the probe is inserted through the seal. Each of the radial sealing surfaces is elastically deformed by the probe when it is inserted through the seal. The two radial sealing surfaces provide guide points to help align and guide the probe when it is inserted through the seal into the receiving chamber. The pair of radial sealing surfaces reduces or eliminates the problem and resulting damage from drag against the female bore and/or galling of the coupling surfaces and seal surfaces.

In the coupling member shown in FIG. 1, the seal (shown separately in FIG. 2) has grooves 77, 78 in its outer circumference. O-rings may be positioned in each of the grooves. In some versions, instead of grooves and O-rings, the seal has a plurality of integral projections which extend radially outwardly from the outer circumference.

In the female coupling member illustrated in FIG. 1, the crown seal 70 is restrained from being imploded into the receiving chamber due to low pressure or vacuum because the seal has an interfit with reverse inclined shoulder surface 62 of seal retainer 29 and reverse inclined shoulder surface 61 of locking member 30—a “dovetail interlocking seal.” The seal retainer may be a cylindrical sleeve that slides into the second diameter 47 of the receiving chamber. When the seal retainer is fully engaged with the female member, first end 46 of the seal retainer abuts shoulder 63. The seal retainer holds hollow radial metal seal 31 on internal shoulder 35.

The seal retainer has a first internal circumferential surface 59 adjacent the first end thereof and a second internal circumferential surface 69 adjacent the second end thereof. The internal diameter of the first inner circumferential surface is smaller than the internal diameter of the second internal circumferential surface. Reverse inclined shoulder 62 is between the first and second internal circumferential surfaces. The reverse inclined shoulder has an interfit with seal 70 to restrain the seal from moving radially inwardly. O-ring 49 is positioned in a groove at the first end 46 of the seal retainer to provide a face-type seal between the seal retainer and shoulder 63.

Locking member (or “retainer nut”) 30 engages the female coupling member using threads 53 or other means. When the locking member is fully secured to the female coupling member, first end 64 abuts the seal retainer and holds the seal retainer in place. The locking member has an internal diameter 54 that allows insertion of the probe of the male member therethrough. Reverse inclined surface 71 holds seal 70 in place and restrains the seal from moving radially inwardly.

The seal length may be chosen based on the length of the probe and/or the depth of the female receiving chamber. Greater spacing of the radial sealing surfaces helps align the male and female coupling members and avoid damage to the metal seal in the coupling. Radial sealing surfaces 75 and 76 extend inwardly from inner circumference 73. Seal 70 is positioned on the second inner circumferential surface 69 of seal retainer 29. Reverse inclined shoulder surfaces 71, 72 interfit with reverse inclined shoulder 61 of the locking member and reverse inclined shoulder 82 of the seal retainer.

As shown in FIG. 2, the outer circumference of the seal has grooves 77, 78 for holding O-rings that seal with inner circumferential surface 69.

FIG. 1 shows a crown seal 70 installed in a seal retainer 29 held within the body of female coupling member 20. However, other designs have also been used for holding the crown seal in place in the coupling member. For example, FIG. 3 shows a crown seal 70 having a dovetail configuration in a seal cartridge. The seal cartridge may hold and secure a plurality of annular seals that may be removed from the coupling member together with the seal cartridge. The seal cartridge comprises a shell 80 that engages the coupling member and a seal carrier 81 that holds the annular seals.

In the prior art coupling shown in FIG. 3, the shell is a generally ring-shaped body with an outer diameter that may have a threaded section 83 to engage the female coupling member. The shell has first end 84, second end 85, first larger inner diameter 86, second smaller inner diameter 87, and internal shoulder 88 between the first and second inner diameters. The shell also may include negative or reverse angle shoulder 89 that extends radially inwardly from internal shoulder 88. Holes 90 may be included in the first end of the shell, and a spanner or other tool may be inserted into the holes to rotate the shell to engage or disengage it from the female member.

The seal carrier 81 is a generally ring shaped sleeve, part of which engages or fits at least partially into the shell. The seal carrier has first end 91 which fits into the shell, second end 92, first larger outer diameter 93, second smaller outer diameter 94, first larger inner diameter 95, and second smaller inner diameter 96. The seal carrier may have negative or reverse angle shoulder 97 between the first larger inner diameter and second smaller inner diameter. The seal carrier also may include outer shoulder 98 between the first larger outer diameter and the second smaller outer diameter.

The first end of the seal carrier slides into the first larger inner diameter 86 of the shell. There may be little or no clearance between the second smaller outer diameter 94 of the seal carrier and the inner diameter 86 of the shell, or there may be a slight interference fit. When the first end of the seal carrier is fully inserted into the shell, the first end 91 may abut internal step 99 of the shell, and/or second end 85 of the shell may abut outer shoulder 98 of the seal carrier.

FIG. 4 shows yet another female coupling member of the prior art which comprises a crown seal 70 having a dovetail configuration. In this design, there is no seal retainer or seal cartridge. Rather, the central axial bore of female member 20 has a section with a first, smaller inner diameter 114 and a section with a second, larger inner diameter 115 with an angled shoulder 110 between the two sections. Angled shoulder 110 engages a corresponding surface on the crown seal 70. The opposite end of the crown seal 70 also has an angled surface that contacts angled surface 111 on retainer nut 112 which is in threaded engagement with the body of the female member 20. As in the designs employing a seal retainer or a seal cartridge, circumferential O-rings 77 and 78 are used to provide a fluid-tight seal between the crown seal and the body of the coupling member.

O-ring seals for high temperature and/or high pressure applications are typically made of specialty elastomers which are costly and not always readily available. In the case of couplings used chemical injection system applications, O-rings can be exposed to chemicals which would rapidly degrade ordinary elastomers. Accordingly, expensive, chemical-resistant materials must be used to fabricate the O-rings. Moreover, having one or more separate circumferential seals on the crown seal increases the part count of the coupling complicating both fabrication and repair processes. The present invention solves this problem.

### BRIEF SUMMARY OF THE INVENTION

A polymeric crown seal for a female hydraulic coupling member comprises integral sealing projections at the juncture of its outer circumference and dovetail shoulders obviating the need for separate O-ring seals. In a first embodiment, the projections have a generally circular cross section and project both radially and axially from the main body of the crown seal. In a second embodiment, the sealing projections comprise a ridge having a rounded distal end and extend only axially from the main body of the crown seal.

Crown seals according to the present invention may be retrofitted in unmodified coupling members including those having seal retainers and those having seal cartridges. Alternatively, as disclosed herein, the receiving chamber of the female member, the seal retainer of a coupling member or the seal carrier of a coupling having a seal cartridge may be specially machined to engage the sealing projections on a crown seal according to the present invention. Likewise, the retainer nuts used to secure dovetail crown seals may have inner surfaces specially contoured to accommodate the corner sealing projections.

Polymeric crown seals according to the present invention may be molded or machined to form. One particular preferred engineering plastic for this application is polyetheretherketone (PEEK).

### BRIEF DESCRIPTION OF THE SEVERAL VIEWS OF THE DRAWING(S)

FIG. 1 is a cross-sectional view of a female hydraulic coupling member of the prior art having a crown seal in a seal retainer.

FIG. 2 is a cross-sectional view of a crown seal of the prior art.

FIG. 3 is a cross-sectional view of a female hydraulic coupling member of the prior art having a crown seal in a seal cartridge.

FIG. 4 is a cross-sectional view of a female hydraulic coupling member of the prior art having a crown seal but no seal cartridge, seal retainer or metal C-seal.

FIG. 5 is a cross-sectional view of a crown seal according to a first embodiment of the invention.

FIG. 5A is an enlargement of a portion of the crown seal shown in FIG. 5.

FIG. 6 is a cross-sectional view of the crown seal illustrated in FIG. 5 installed in a female hydraulic coupling having a seal retainer.

FIG. 7 is a cross-sectional view of the crown seal illustrated in FIG. 5 installed in a female hydraulic coupling having a seal cartridge.

FIG. 8 is a cross-sectional view of the crown seal illustrated in FIG. 5 installed in a female hydraulic coupling having a seal retaining nut.

FIG. 9 is a cross-sectional view of the crown seal illustrated in FIG. 5 installed in a female hydraulic coupling having a seal retainer specially adapted for engaging the sealing protrusions on the crown seal.

FIG. 10A is an enlarged cross-sectional view of a first portion of a crown seal and mating surface of a first type.

FIG. 10B is an enlarged cross-sectional view of a second portion of a crown seal and mating surface of a first type.

FIG. 11A is an enlarged cross-sectional view of a first portion of a crown seal and mating surface of a second type.

FIG. 11B is an enlarged cross-sectional view of a second portion of a crown seal and mating surface of a second type.

FIG. 12 is a cross-sectional view of the crown seal illustrated in FIG. 5 installed in a female hydraulic coupling having a seal cartridge specially adapted for engaging the sealing protrusions on the crown seal.

FIG. 13 is a cross-sectional view of the crown seal illustrated in FIG. 5 installed in a female hydraulic coupling having a body specially adapted for engaging the sealing protrusions on the crown seal.

FIG. 14 is a cross-sectional view of a crown seal according to a second embodiment of the invention.

FIG. 14A is an enlargement of a portion of the crown seal shown in FIG. 14.

FIG. 15 is a cross-sectional view of the crown seal illustrated in FIG. 14 installed in a female hydraulic coupling having a seal retainer.

FIG. 16 is a cross-sectional view of the crown seal illustrated in FIG. 14 installed in a female hydraulic coupling having a seal retainer specially adapted to engage a sealing protrusion on the crown seal.

FIG. 17 is a cross-sectional view of the crown seal illustrated in FIG. 14 installed in a female hydraulic coupling having a seal cartridge.

FIG. 18 is a cross-sectional view of the crown seal illustrated in FIG. 14 installed in a female hydraulic coupling having a seal cartridge specially adapted to engage a sealing protrusion on the crown seal.

FIG. 19 is a cross-sectional view of the crown seal illustrated in FIG. 14 installed in the body of a female hydraulic coupling having a threaded retaining nut adapted to engage the sealing protrusion.

FIG. 19A is an enlargement of a first portion of the female hydraulic coupling shown in FIG. 19.

FIG. 19B is an enlargement of a second portion of the female hydraulic coupling shown in FIG. 19B.

FIG. 20 is a cross-sectional view of the crown seal illustrated in FIG. 14 installed in a female hydraulic coupling whose body is specially adapted to engage a sealing protrusion on the crown seal.

FIG. 20A is an enlargement of a first portion of the female hydraulic coupling shown in FIG. 20.

FIG. 20B is an enlargement of a second portion of the female hydraulic coupling shown in FIG. 20.

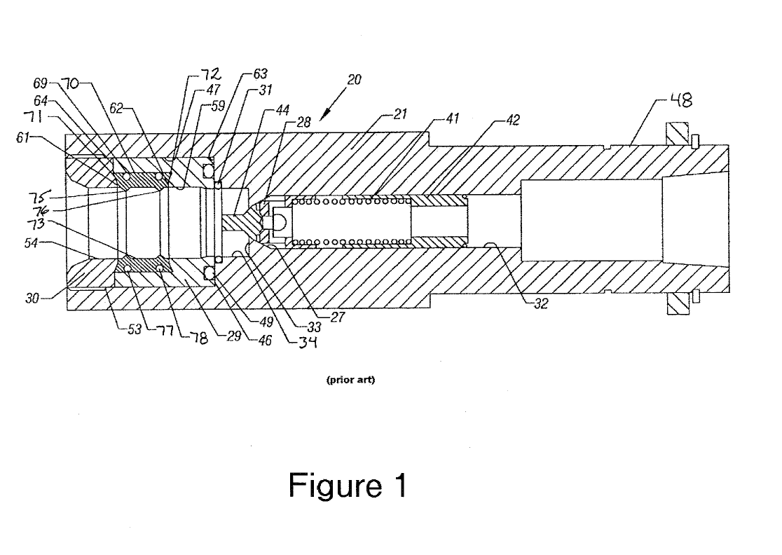

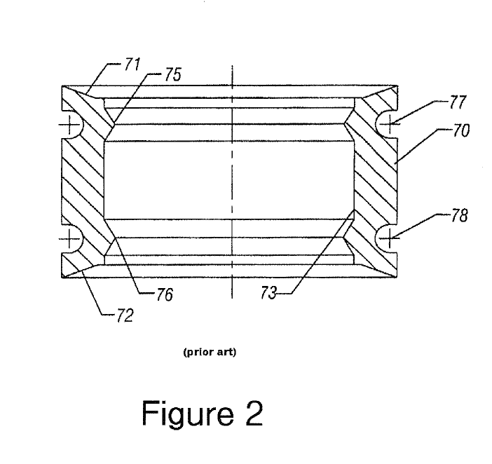

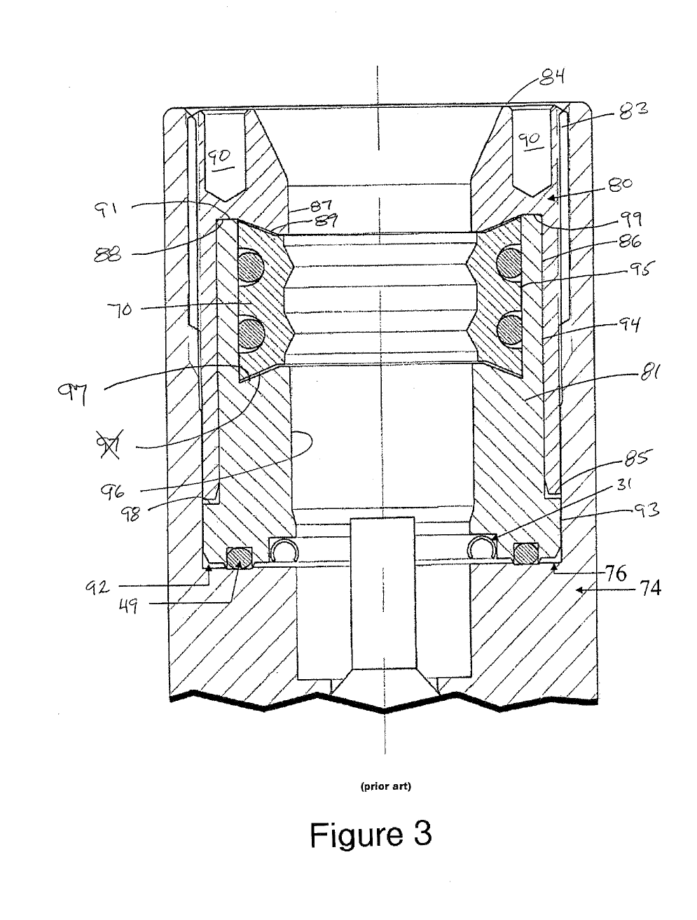

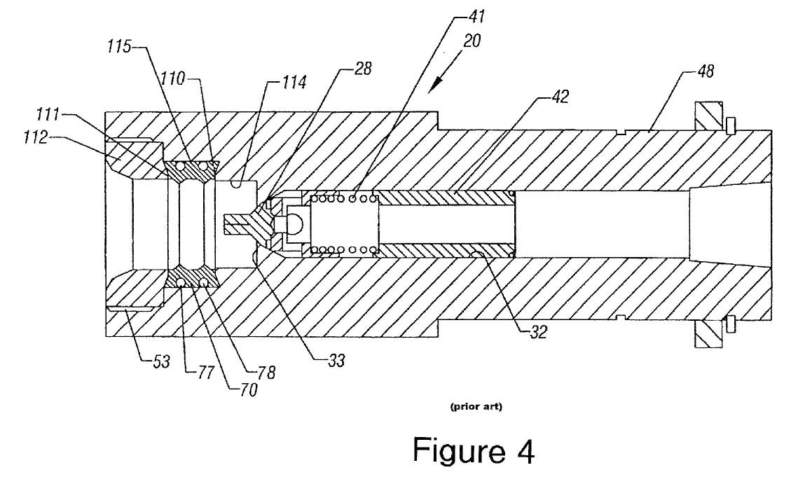

### DETAILED DESCRIPTION OF THE INVENTION

The invention may best be understood by reference to the accompanying drawing figures which illustrate two embodiments of the crown seal of the invention installed in both prior art female hydraulic coupling members and female coupling members according to the invention.

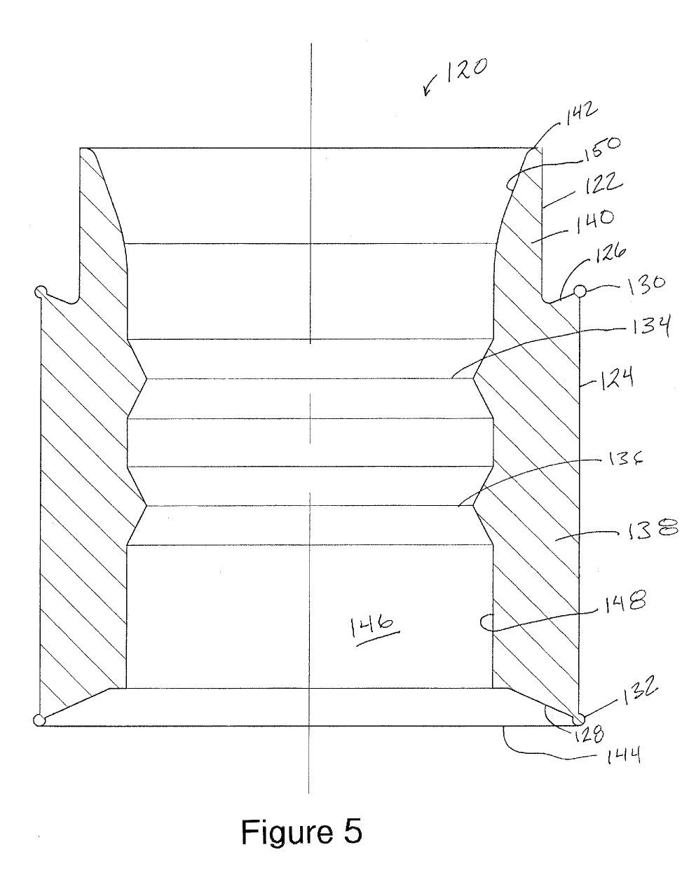

FIG. 5 shows in cross section a crown seal 120 according to a first embodiment of the invention. Crown seal 120 is a generally cylindrical structure having a stepped outer diameter comprised of a first, outer section having smaller outside diameter 122 and a second, inner section having a larger outside diameter 124. Inclined shoulder 126 forms the juncture of the two sections 122 and 124. Crown seal 120 has a first, outer end 142 and a second, inner end 144 with a central, axial bore 146 which forms the receiving chamber for the male probe when seal 120 is installed in a female hydraulic coupling member. The terms “inner” and “outer” as used herein refer to the orientation of seal 120 as installed in a female coupling member. Outer end 142 is distal from the center (or interior) of the coupling while inner end 144 is proximal the center of the coupling. Angled surface 128 is adjacent inner end 144 of seal 120.

One or more sealing surfaces 134, 136 project into central axial bore 146 to seal against the outer, generally cylindrical surface of a male hydraulic probe (not shown) when inserted into the receiving chamber 146. Although a single probe seal (134 or 136) may suffice for sealing purposes, it has been found that the provision of multiple probe seals helps to ensure proper alignment of the male member during insertion into receiving chamber 146.

Angled surfaces 126 and 128 form a dovetail interlock with corresponding surfaces in the female member (as described more fully, below). This interlock acts to resist the forces acting to urge the seal in a radial, inward direction (“seal implosion”) which may be encountered during withdrawal of the male member. As used herein, “angled surface” or “angled shoulder” mean an element that is not orthogonal to the central axis of the body—i.e., not “square.” Stated another way, an “angled surface” or “angled body” forms an angle other than 90° with the major axis of the body.

Section 140 of crown seal 120 is an optional, bore liner extension. Within section 140, the inner diameter of central, axial bore 146 may be progressively increased towards first end 142 from smaller internal diameter 148 to larger internal diameter 150. Bore liner extension 140 lines the internal bore of the female hydraulic coupling member and prevents metal-to-metal contact (with possible consequential galling) between the male probe and the receiving chamber of the female member. The progressive reduction (in the inward direction) of the internal diameter in section 140 acts as a cam to direct a misaligned male probe into axial alignment as it is inserted into receiving chamber 146.

Body 138 of crown seal 120 may be fabricated from any suitable material. Polymers are particularly preferred for sealing effectiveness. Fabrication techniques include, but are not limited to, molding and machining. One, particularly preferred material for body 138 is polyetheretherketone (PEEK). PEEK is a thermoplastic with very favorable mechanical properties. The Young's modulus of PEEK is given as 3.6 GPa (522,000 psi) and its tensile strength 170 MPa (25,000 psi). PEEK is partially crystalline, and is highly unusual in exhibiting two glass transition temperatures at around 140° C. (284° F.) and around 275° C. (527° F.), depending on cure cycle and precise formulation. PEEK melts at around 350° C. (662° F.) and is highly resistant to thermal degradation. PEEK also exhibits good chemical resistance over a wide temperature range in many environments, including alkalis, aromatic hydrocarbons, alcohols, greases, oils and halogenated hydrocarbons. A crown seal according to the present invention may be machined from PEEK bar stock. It has been found that extruded PEEK bar stock is superior in this application to molded PEEK bar stock.

Another particularly preferred material for the fabrication of body 138 is polyoxymethylene (POM), also commonly known by DuPont's brand name DELRIN. It is an engineering plastic, (a polymer) with the chemical formula —(—O—CH2—)n—. Often marketed and used as a metal substitute, Delrin is a lightweight, low-friction, and wear-resistant thermoplastic with good physical and processing properties capable of operating in temperatures in excess of 90 degrees Celsius (approx 200 degrees Fahrenheit). When supplied as extruded bar or sheet, DELRIN may be machined using traditional methods such as turning, milling, drilling, etc.

Yet another preferred material for the fabrication of body 138 is polytetrafluoroethylene (PTFE), a synthetic fluoropolymer which finds numerous applications. PTFE is often referred to by the DuPont brand name TEFLON.

Crown seal 120 includes one or more sealing projections 130, 132 on or near its outer circumference. In the embodiment illustrated in FIG. 5, sealing projections 130 and 132 have a generally circular cross section and project in both a radial and axial direction from the outer surface of body 138. Sealing projection 130 is located at the juncture of angled shoulder 126 and outer diameter 124. FIG. 5A is an enlarged detail of sealing projection 130 and the immediately adjacent portions of crown seal 120. Sealing projection 132 is located at the juncture of angled surface 128 and outer diameter 124. The size of sealing projection 130 and/or 132 may be selected according to the particular application. In one particular preferred embodiment wherein outer diameter 124 is approximately 0.895 inch, the diameter of the circular portions of sealing projections 130 and 132 is approximately 0.007 inch. In embodiments having a plurality of sealing projections, the size of each sealing projection may be the same as or different from other sealing projections.

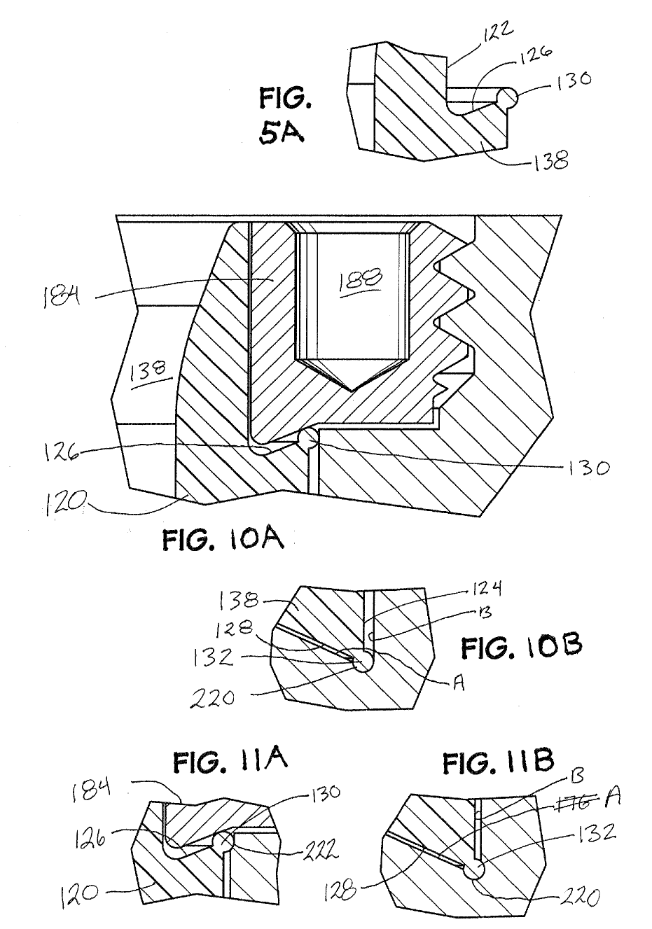

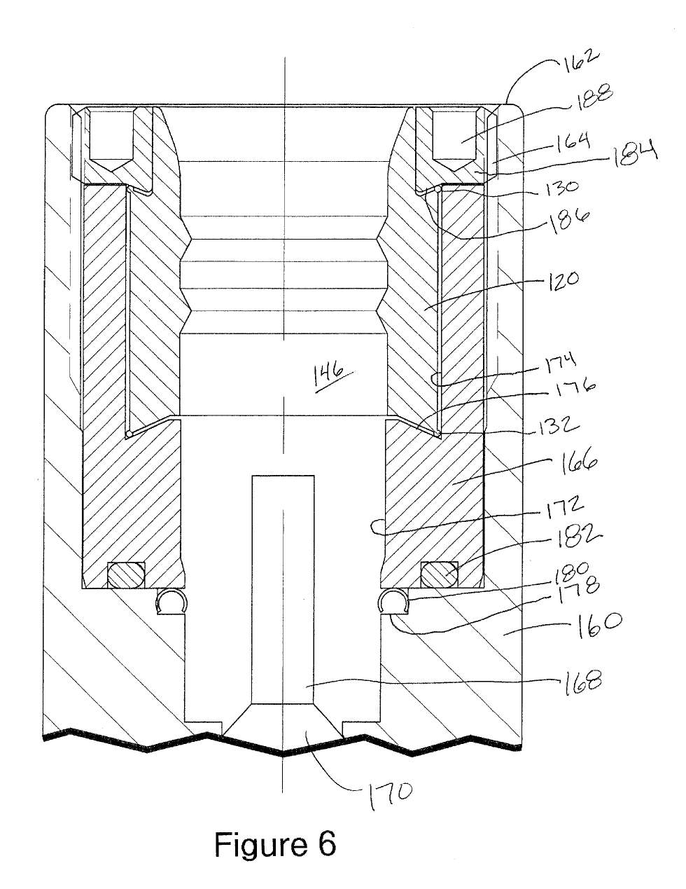

FIG. 6 shows a portion of a female hydraulic coupling member 160 comprising a crown seal 120 of the type illustrated in FIG. 5. A portion of poppet valve 170 and its associated valve actuator 168 are visible in the drawing figure. Coupling 160 includes seal retainer 166, a generally sleeve-shaped member having a stepped inner diameter with an inner section of smaller I.D. 172 and an outer section of larger I.D. 174 and angled shoulder 176 joining the two sections. The inner face of seal retainer 166 has a ring-shaped groove for holding O-ring 182 which provides a fluid-tight seal between seal retainer 166 and the body of female member 160.

In the embodiment illustrated in FIG. 6, the inner face of seal retainer 166 also secures metal C-seal 180 on shoulder 178 of the central axial bore of female member 160. C-seal 180 provides a pressure-energized seal between the female member and the probe of a male member inserted into receiving chamber 146.

Seal retainer 166 is held within the central axial bore of female member 160 by threaded retainer nut 184 which may comprise spanner holes 188 for engaging a tool to assist in seating and removing retainer nut 184. The central axial bore of female member 160 may include internally threaded portion 164 proximate first end 162 for engaging the retainer nut 184. Retainer nut 184 may comprise angled surface 186 sized and spaced to engage angled shoulder 126 of crown seal 120. Likewise, seal retainer 166 may comprise angled shoulder 176 sized and spaced to engage angled surface 128 of crown seal 120. In this way, the seal retainer 166 acting in concert with retainer nut 184 provides a dovetail type interlock with crown seal 120 to resist inward radial movement of seal 120.

Crown seal 120 is preferably sized such that sealing projections 130 and 132 are slightly compressed when retainer nut 184 is tightened against seal retainer 166 and seal retainer 166 is fully seated on shoulder 177. In so doing, sealing projection 132 provides a fluid-tight seal between crown seal 120 and seal retainer 166 and sealing projection 130 provides a fluid-tight seal both between crown seal 120 and retainer nut 184 and between crown seal 120 and seal retainer 166.

It will be appreciated that seal retainer 166 and retainer nut 184 of FIG. 6 are according to a design of the prior art (see, e.g. U.S. Pat. No. 4,900,071 to Robert E. Smith III). Thus, a crown seal 120 according to the present invention may be retrofitted to a female coupling member 160 by simply replacing the prior art crown seal—i.e. a crown seal having one or more circumferential O-ring seals or radial sealing projections.

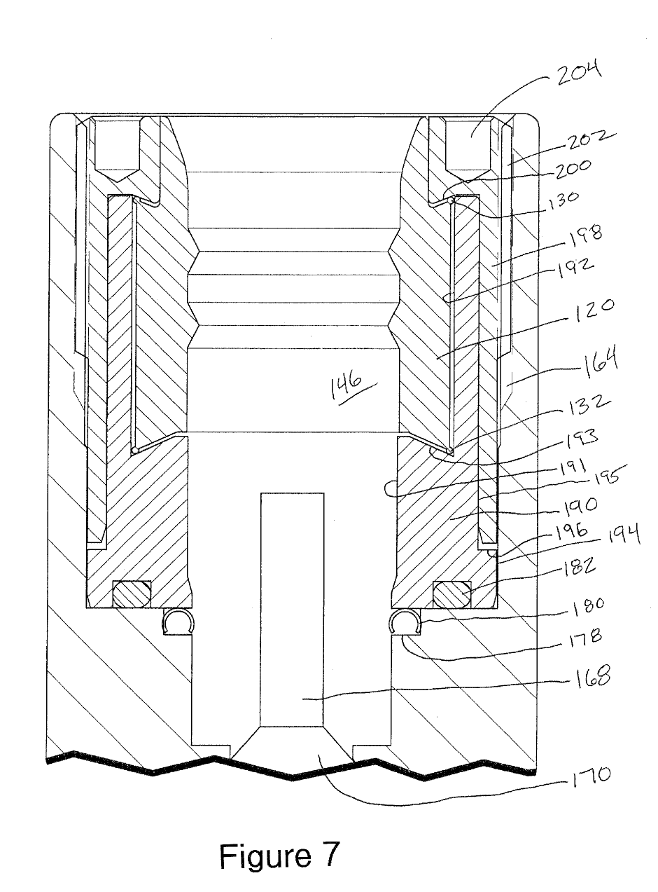

FIG. 7 shows a crown seal 120 of the type illustrated in FIG. 5 in a female hydraulic coupling member having a seal cartridge comprised of seal carrier 190 and shell 198. Seal carrier 190 is a generally sleeve-shaped member having both a stepped inner diameter and a stepped outer diameter. Angled shoulder 193 connects the inner portion having smaller I.D. 191 with the outer portion having larger I.D. 192. Square shoulder 196 joins the inner portion having larger O.D. 194 with the outer portion having smaller O.D. 195. Angled shoulder 193 is sized and spaced to engage angled surface 128 of crown seal 120.

Shell 198 is externally threaded in threaded portion 202 to engage the internally threaded portion 164 of the bore of the female coupling member. Spanner holes 204 may be provided to engage a tool for seating and removing the seal cartridge in the female coupling member. Shell 198 may have a slight interference fit with the portion of seal carrier 190 having smaller O.D. 195. In this way, the entire seal cartridge including crown seal 120 may be removed for service from the female member by unthreading shell 198 from the bore of the female member.

Shell 198 preferably comprises angled shoulder 200 sized and spaced to engage angled shoulder 126 on crown seal 120. Together with shoulder 193, angled shoulder 200 provides a dovetail-type interlock with surfaces 126 and 128 of crown seal 120 which resists implosion—i.e., inward radial movement—of crown seal 120 into receiving chamber 146 under conditions of low pressure in chamber 146 such as may be encountered during withdrawal of the male probe.

Crown seal 120 is preferably sized such that sealing projections 130 and 132 are slightly compressed when shell 198 of the seal cartridge is tightened against seal carrier 190 and seal carrier 190 is fully seated on shoulder 177. In so doing, sealing projection 132 provides a fluid-tight seal between crown seal 120 and seal carrier 190 and sealing projection 130 provides a fluid-tight seal both between crown seal 120 and shell 198 and between crown seal 120 and seal carrier 190.

It will be appreciated that the seal cartridge comprised of seal carrier 190 and shell 198 of FIG. 7 is according to a design of the prior art (see, e.g. U.S. Pat. No. 7,021,677 to Robert E. Smith III). Thus, a crown seal 120 according to the present invention may be retrofitted to a female coupling member having a seal cartridge by simply replacing the prior art crown seal—i.e. a crown seal having one or more circumferential O-ring seals or radial sealing projections.

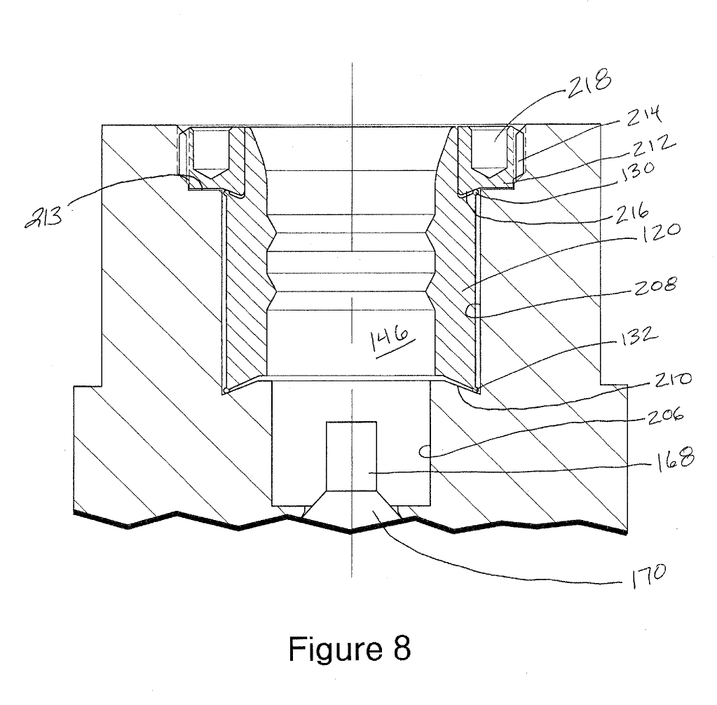

FIG. 8 shows the use of a crown seal 120 according to the present invention in a female coupling member having neither a seal retainer nor a seal cartridge. Rather, the central axial bore of the female member has a first, inner section having smaller I.D. 206 and a second, outer section having larger I.D. 208 connected by angled shoulder 210. Angled shoulder 210 engages angled surface 128 of crown seal 120.

Retainer nut 212 is externally threaded with threads 214 for engaging a threaded section of the central axial bore of the female member. Spanner holes 218 may be provided for engaging a tool for the insertion and removal of nut 212. Retainer nut 212 comprises angled surface 216 sized and spaced to engage angled shoulder 126 of crown seal 120. Angled shoulder 210 together with angled surface 216 provide a dovetail interlock with surfaces 126 and 128 of crown seal 120 which resists implosion—i.e., inward radial movement—of crown seal 120 into receiving chamber 146 under conditions of low pressure in chamber 146 such as may be encountered during withdrawal of the male probe.

Crown seal 120 is preferably sized such that sealing projections 130 and 132 are slightly compressed when retainer nut 212 is fully seated on shoulder 213. In so doing, sealing projection 132 provides a fluid-tight seal between crown seal 120 and the body of the female member and sealing projection 130 provides a fluid-tight seal both between crown seal 120 and retainer nut 212 and between crown seal 120 and the body of the female coupling member.

It will be appreciated that the body of the female coupling member of FIG. 8 and retaining nut 212 are according to a design of the prior art (see, e.g. U.S. Pat. No. 6,575,430 to Robert E. Smith III). Thus, a crown seal 120 according to the present invention may be retrofitted to such a female coupling member by simply replacing the prior art crown seal—i.e. a crown seal having one or more circumferential O-ring seals or radial sealing projections.

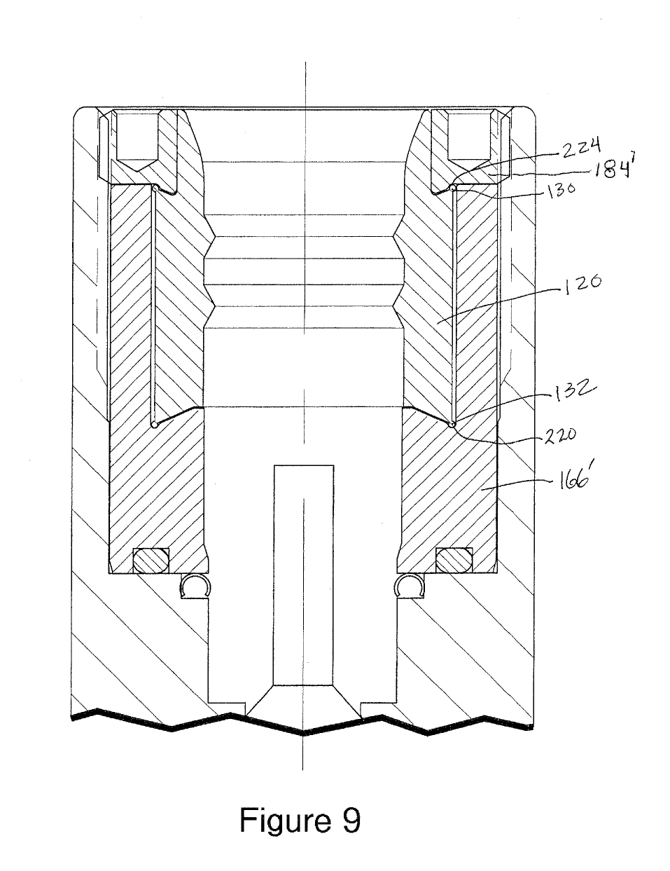

FIG. 9 shows a female coupling member of the type illustrated in FIG. 6—i.e., a female coupling member having a seal retainer. In this embodiment, seal retainer 166′ is modified to accommodate corner sealing projection 132 and/or corner sealing projection 130. Retainer nut 184′ may also be modified to accommodate corner sealing projection 130 on crown seal 120.

FIG. 10A is an enlarged detail of the contact area of retainer nut 184 and crown seal 120 as shown in FIG. 9.

FIG. 10B is an enlargement showing groove 220 between angled shoulder 176 (“A” in FIG. 10B) and the section of seal retainer 166′ having larger I.D. 174 (“B” in FIG. 10B). Groove 220 is preferably sized such that corner sealing projection 132 will fit at least partially into groove 220 and thereby provide greater sealing contact between seal retainer 166′ and crown seal 120. FIG. 11B shows an alternative embodiment wherein groove 220 is undercut relative to section “B” to provide greater contact area to with sealing projection 132.

FIG. 11A shows an alternative configuration for seal retainer 166′ wherein contour 222 is provided on the interior surface of seal retainer 166′ for accommodating corner sealing projection 130 on crown seal 120. Either one or both of groove 220 and contour 222 may be provided on seal retainer 166′. The contour embodiment shown in FIG. 11A may conveniently be used with the groove embodiment shown in FIG. 11B.

As shown in FIG. 9, retainer nut 184′ may be provided with contour 224 for contacting corner sealing projection 130 on seal 120. Groove 220 and/or contour 222 and/or contour 224 may increase the sealing effectiveness of corner sealing projections 130 and 132 of crown seal 120 by providing a larger area of contact between seal retainer 166′ and/or nut 184′ and the corner sealing projections 130 and 132.

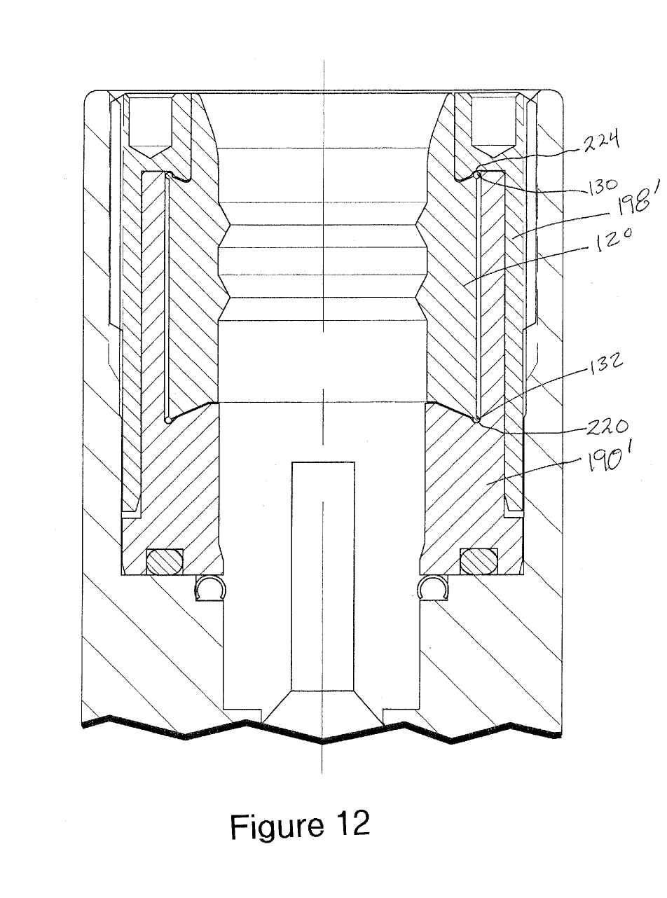

FIG. 12 shows a female coupling member of the type illustrated in FIG. 7—i.e., a female coupling member having a seal cartridge. In this embodiment, seal carrier 190′ is modified to accommodate corner sealing projection 132 and/or corner sealing projection 130. Shell 198′ may also be modified to accommodate corner sealing projection 130 on crown seal 120.

FIG. 10B is an enlargement showing groove 220 between angled shoulder 193 (“A” in FIG. 10B) and the section of seal carrier 190′ having larger I.D. 192 (“B” in FIG. 10). Groove 220 is preferably sized such that corner sealing projection 132 will fit at least partially into groove 220 and thereby provide greater sealing contact between seal carrier 190′ and crown seal 120.

FIG. 11A shows an alternative configuration for seal carrier 190′ wherein contour 222 is provided on the interior surface of seal carrier 190′ for accommodating corner sealing projection 130 on crown seal 120. Either one or both of groove 220 and contour 222 may be provided on seal carrier 190′.

As shown in FIG. 12, shell 198′ may be provided with contour 224 for contacting corner sealing projection 130 on seal 120. Groove 220 and/or contour 222 and/or contour 224 may increase the sealing effectiveness of corner sealing projections 130 and 132 of crown seal 120 by providing a larger area of contact between seal carrier 190′ and/or shell 198′ and the corner sealing projections 130 and 132.

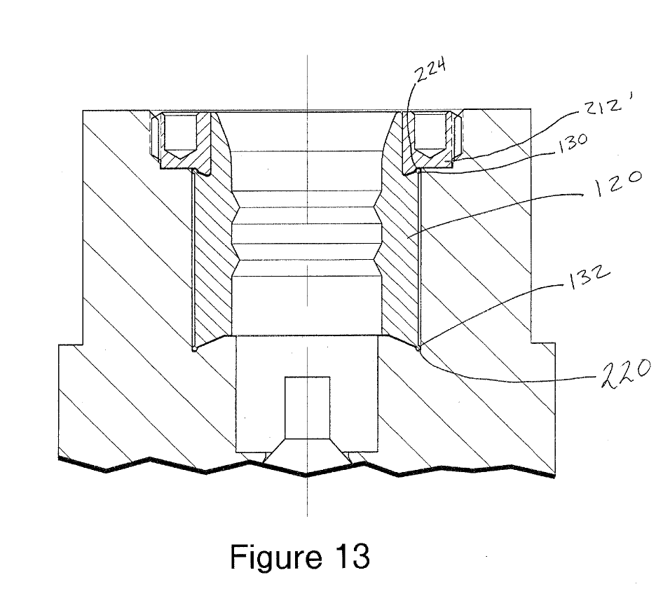

FIG. 13 shows a female coupling member of the type illustrated in FIG. 8—i.e., a female coupling member having no seal cartridge, seal retainer or metal C-seal. In this embodiment, the body of the female member is modified to accommodate corner sealing projection 132 and/or corner sealing projection 130. Retainer nut 212′ may also be modified to accommodate corner sealing projection 130 on crown seal 120.

FIG. 10B is an enlargement showing groove 220 between angled shoulder 210 (“A” in FIG. 10B) and the portion of the central axial bore of the female member having larger I.D. 208 (“B” in FIG. 10B). Groove 220 is preferably sized such that corner sealing projection 132 will fit at least partially into groove 220 and thereby provide greater sealing contact between the body of female member 160 and crown seal 120.

FIG. 11 shows an alternative configuration for the female bore wherein contour 222 is also provided on the interior surface of the central axial bore for accommodating corner sealing projection 130 on crown seal 120. Either one or both of groove 220 and contour 222 may be provided on the interior surface of the central axial bore.

As shown in FIG. 13, retainer nut 212′ may be provided with contour 224 for contacting corner sealing projection 130 on seal 120. Groove 220 and/or contour 222 and/or contour 224 may increase the sealing effectiveness of corner sealing projections 130 and 132 of crown seal 120 by providing a larger area of contact between the body of female member 160 and/or retainer nut 212′ and the corner sealing projections 130 and 132.

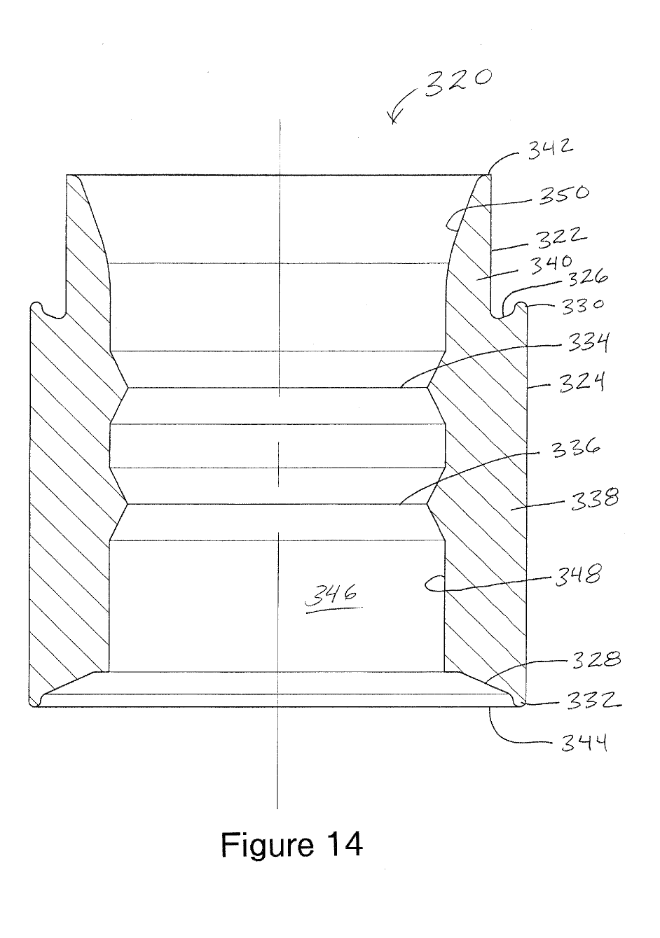

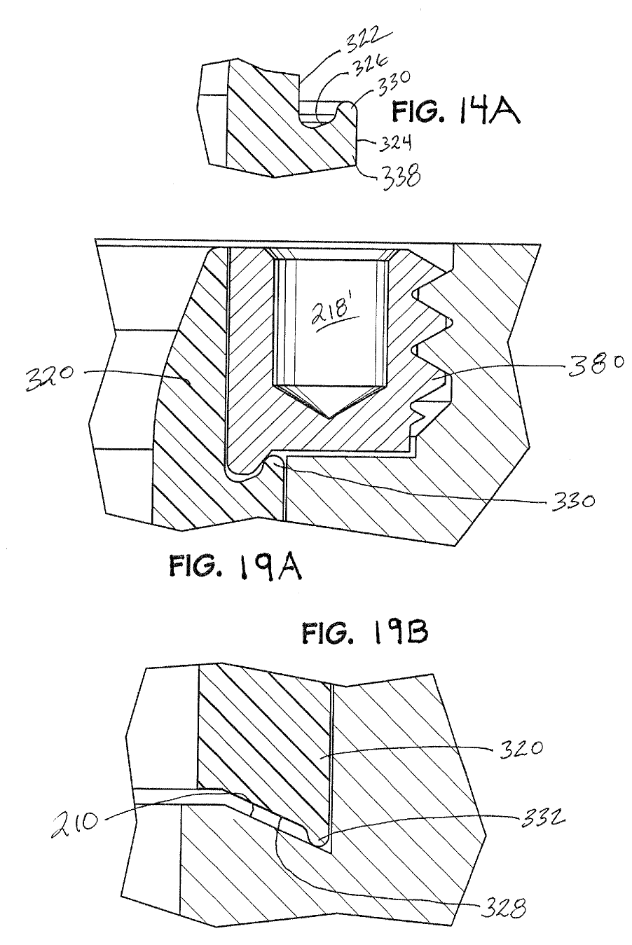

A crown seal according to a second embodiment of the invention is shown in FIG. 14. This embodiment has sealing projections on the exterior surface of the seal which project only in the axial direction—i.e., the outside diameter of seal is not affected by the practice of the invention. This feature is of particular benefit in certain applications wherein a seal according to the invention is retrofitted to an existing coupling member.

Crown seal 320 is a generally cylindrical structure having a stepped outer diameter comprised of a first, outer section having smaller outside diameter 322 and a second, inner section having a larger outside diameter 324. Inclined shoulder 326 forms the juncture of the two sections 322 and 324. Crown seal 320 has a first, outer end 342 and a second, inner end 344 with a central, axial bore 346 which forms the receiving chamber for the male probe when seal 320 is installed in a female hydraulic coupling member. The terms “inner” and “outer” as used herein refer to the orientation of seal 320 as installed in a female coupling member. Outer end 342 is distal from the center (or interior) of the coupling while inner end 344 is proximal the center of the coupling. Angled surface 328 is adjacent inner end 344 of seal 320.

One or more sealing surfaces 334, 336 project into central axial bore 346 to seal against the outer, generally cylindrical surface of a male hydraulic probe (not shown) inserted into the receiving chamber 346. Although a single probe seal (134 or 336) may suffice for sealing purposes, it has been found that the provision of multiple probe seals helps to ensure proper alignment of the male member during insertion into receiving chamber 346.

Angled surfaces 326 and 328 form a dovetail interlock with corresponding surfaces in the female member (as described more fully, below). This interlock acts to resist the forces acting to urge the seal in a radial, inward direction (“seal implosion”) which may be encountered during withdrawal of the male member.

Section 340 of crown seal 320 is an optional, bore liner extension. Within section 340, the inner diameter of central, axial bore 346 may be progressively increased towards first end 342 from smaller internal diameter 348 to larger internal diameter 350. Bore liner extension 340 lines the internal bore of the female hydraulic coupling member and prevents metal-to-metal contact (with possible consequential galling) between the male probe and the receiving chamber of the female member. The progressive reduction (in the inward direction) of the internal diameter in section 340 acts as a cam to direct a misaligned male probe into axial alignment as it is inserted into receiving chamber 346.

Body 338 of crown seal 320 may be fabricated from any suitable material. PEEK and POM polymers are particularly preferred, as described above in connection with the embodiment shown in FIG. 5.

Crown seal 320 includes one or more axial sealing projections 330, 332 on or near its outer circumference. In the embodiment illustrated in FIG. 5, sealing projections 330 and 332 have a distal portion with a generally semicircular circular cross section and project in an axial direction from the outer surface of body 338. Sealing projection 330 is located at the juncture of angled shoulder 326 and outer diameter 324. FIG. 14A is an enlarged, detail view showing sealing projection 330 and the immediately adjacent portions of crown seal 320. Sealing projection 332 is located at the juncture of angled surface 328 and outer diameter 324. The size of sealing projection 330 and/or 332 may be selected according to the particular application. In one particular preferred embodiment wherein outer diameter 324 is approximately 0.895 inch, the diameter of the semicircular portions of sealing projections 330 and 332 is approximately 0.007 inch. In embodiments having a plurality of axial sealing projections, the size of each sealing projection may be the same as or different from other axial sealing projections.

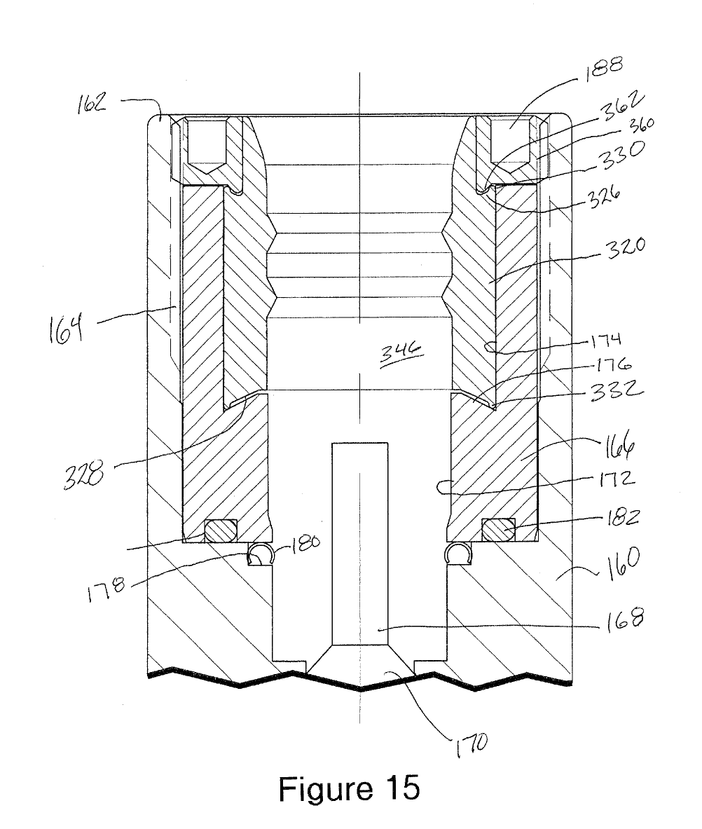

FIG. 15 shows a portion of a female hydraulic coupling member 160 comprising a crown seal 320 of the type illustrated in FIG. 14. A portion of poppet valve 170 and its associated valve actuator 168 are visible in the drawing figure. Coupling 160 includes seal retainer 166, a generally sleeve-shaped member having a stepped inner diameter with an inner section of smaller I.D. 172 and an outer section of larger I.D. 174 and angled shoulder 176 joining the two sections. The inner face of seal retainer 166 has a ring-shaped groove for holding O-ring 182 which provides a fluid-tight seal between seal retainer 166 and the body of female member 160.

In the embodiment illustrated in FIG. 15, the inner face of seal retainer 166 also secures metal C-seal 180 on shoulder 178 of the central axial bore of female member 160. C-seal 180 provides a pressure-energized seal between the female member and the probe of a male member inserted into receiving chamber 346.

Seal retainer 166 is held within the central axial bore of female member 160 by threaded retainer nut 360 which may comprise spanner holes 188 for engaging a tool to assist in seating and removing retainer nut 360. The central axial bore of female member 160 may include internally threaded portion 164 proximate first end 162 for engaging the retainer nut 360. Retainer nut 360 may comprise contoured angled surface 362 sized and spaced to engage both angled shoulder 326 of crown seal 320 and axial sealing projection 330. Likewise, seal retainer 166 may comprise angled shoulder 176 sized and spaced to engage angled surface 328 of crown seal 320. In this way, the seal retainer 166 acting in concert with retainer nut 360 provides a dovetail type interlock with crown seal 320 to resist inward radial movement of seal 320.

Crown seal 320 is preferably sized such that axial sealing projections 330 and 332 are slightly compressed when retainer nut 360 is tightened against seal retainer 166 and seal retainer 166 is fully seated on shoulder 177. In so doing, sealing projection 332 provides a fluid-tight seal between crown seal 320 and seal retainer 166 and sealing projection 330 provides a fluid-tight seal both between crown seal 320 and retainer nut 360 and between crown seal 320 and seal retainer 166.

It will be appreciated that seal retainer 166 of FIG. 15 is according to a design of the prior art (see, e.g. U.S. Pat. No. 5,052,439 to Robert E. Smith III). Thus, a crown seal 320 according to the present invention may be retrofitted to a female coupling member 160 by simply replacing the prior art crown seal—i.e. a crown seal having one or more circumferential O-ring seals or radial sealing projections. Optionally, retainer nut 360 having contoured angled shoulder 362 may also be retrofitted to the coupling member to increase the sealing effectiveness of axial sealing projection 330.

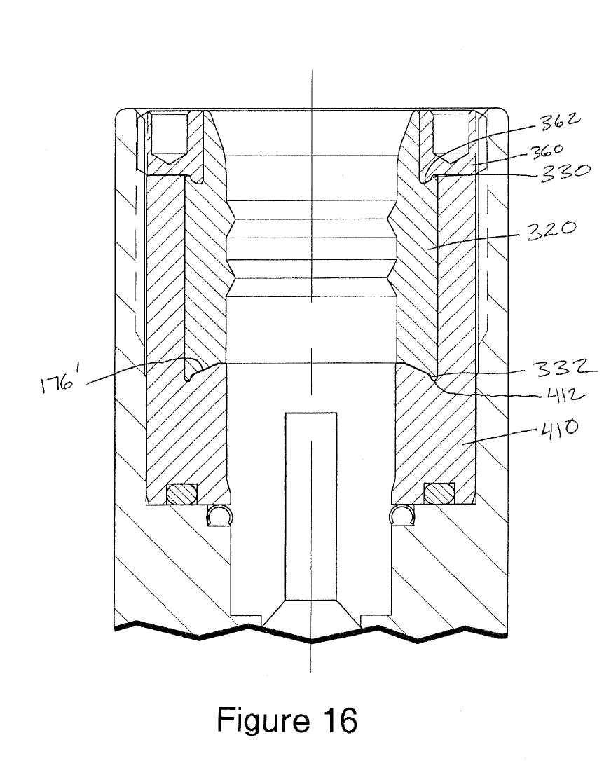

FIG. 16 shows a female coupling member of the type illustrated in FIG. 15—i.e., a female coupling member having a seal retainer. In this embodiment, seal retainer 410 is modified to accommodate axial sealing projection 332. The modification comprises groove 412 at the outer edge of angled shoulder 176′ of seal retainer 410. Groove 412 is preferably sized and spaced to accommodate axial sealing projection 332 on crown seal 320 thereby increasing its sealing effectiveness by providing a greater area of contact as compared to the embodiment illustrated in FIG. 15.

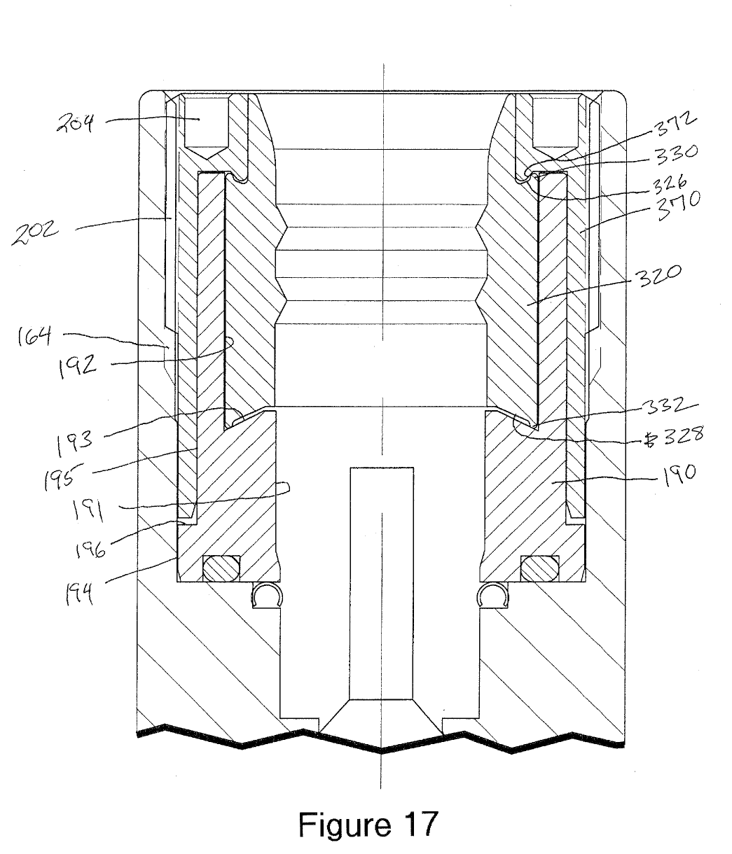

FIG. 17 shows a crown seal 320 of the type illustrated in FIG. 14 in a female hydraulic coupling member having a seal cartridge comprised of seal carrier 190 and shell 370. Seal carrier 190 is a generally sleeve-shaped member having both a stepped inner diameter and a stepped outer diameter. Angled shoulder 193 connects the inner portion having smaller I.D. 191 with the outer portion having larger I.D. 192. Square shoulder 196 joins the inner portion having larger O.D. 194 with the outer portion having smaller O.D. 195. Angled shoulder 193 is sized and spaced to engage angled surface 328 of crown seal 320.

Shell 370 is externally threaded in threaded portion 202 to engage the internally threaded portion 164 of the bore of the female coupling member. Spanner holes 204 may be provided to engage a tool for seating and removing the seal cartridge in the female coupling member. Shell 370 may have a slight interference fit with the portion of seal carrier 190 having smaller O.D. 195. In this way, the entire seal cartridge including crown seal 320 may be removed for service from the female member by unthreading shell 370 from the bore of the female member.

Shell 370 preferably comprises contoured angled shoulder 372 sized and spaced to engage angled shoulder 326 and axial sealing projection 330 on crown seal 320. Together with shoulder 193, contoured angled shoulder 372 provides a dovetail-type interlock with surfaces 326 and 328 of crown seal 320 which resists implosion—i.e., inward radial movement—of crown seal 320 into receiving chamber 346 under conditions of low pressure in chamber 346 such as may be encountered during withdrawal of the male probe.

Crown seal 320 is preferably sized such that axial sealing projections 330 and 332 are slightly compressed when shell 198 of the seal cartridge is tightened against seal carrier 190 and seal carrier 190 is fully seated on shoulder 177. In so doing, sealing projection 332 provides a fluid-tight seal between crown seal 320 and seal carrier 190 and sealing projection 330 provides a fluid-tight seal both between crown seal 320 and shell 198 and between crown seal 320 and seal carrier 190.

It will be appreciated that the seal cartridge comprised of seal carrier 190 and shell 198 of FIG. 17 is according to a design of the prior art (see, e.g. U.S. Pat. No. 7,163,190 to Robert E. Smith III). Thus, a crown seal 320 according to the present invention may be retrofitted to a female coupling member having a seal cartridge by simply replacing the prior art crown seal—i.e. a crown seal having one or more circumferential O-ring seals or radial sealing projections.

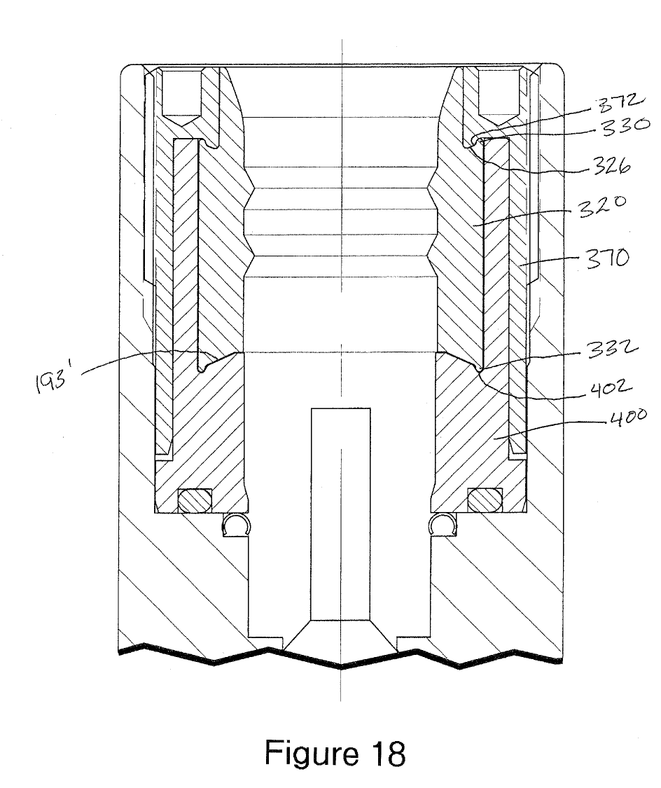

FIG. 18 shows a female coupling member of the type illustrated in FIG. 17—i.e., a female coupling member having a seal cartridge. In this embodiment, seal carrier 400 is modified to accommodate axial sealing projection 332. Groove 402 at the outer portion of angled shoulder 193′ is sized and spaced to fit axial sealing projection 332 on seal 320. Shell 370 may also be modified to accommodate axial sealing projection 330 on crown seal 320 by the provision of contoured angled shoulder 372 which may be sized and contoured to fit both angled shoulder 326 and axial sealing projection 330 of seal 320.

Groove 402 and/or contoured surface 372 may increase the sealing effectiveness of axial sealing projections 330 and 332 of crown seal 320 by providing a larger area of contact between seal carrier 400 and/or shell 370 and the axial sealing projections 330 and 332.

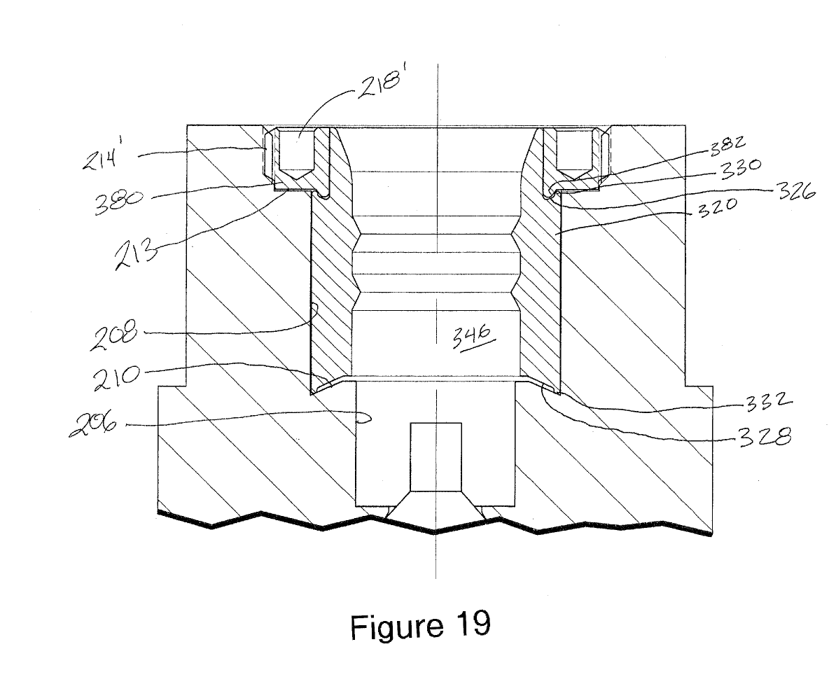

FIG. 19 shows the use of a crown seal 320 according to the present invention in a female coupling member having neither a seal retainer nor a seal cartridge. Rather, the central axial bore of the female member has a first, inner section having smaller I.D. 206 and a second, outer section having larger I.D. 208 connected by angled shoulder 210. Angled shoulder 210 engages angled surface 328 of crown seal 320.

Retainer nut 380 is externally threaded with threads 214′ for engaging a threaded section of the central axial bore of the female member. Spanner holes 218′ may be provided for engaging a tool for the insertion and removal of nut 380. Retainer nut 380 comprises contoured angled surface 382 sized and spaced to engage angled shoulder 326 and axial sealing projection 330 of crown seal 320. Angled shoulder 210 together with angled surface 326 provide a dovetail interlock with surfaces 326 and 328 of crown seal 320 which resists implosion—i.e., inward radial movement—of crown seal 320 into receiving chamber 346 under conditions of low pressure in chamber 346 such as may be encountered during withdrawal of the male probe.

Crown seal 320 is preferably sized such that sealing projections 330 and 332 are slightly compressed when retainer nut 380 is fully seated on shoulder 213. In so doing, sealing projection 332 provides a fluid-tight seal between crown seal 320 and the body of the female member and sealing projection 330 provides a fluid-tight seal both between crown seal 320 and retainer nut 380 and between crown seal 320 and the body of the female coupling member. FIG. 19A is an enlargement of the contact region between sealing projection 330 and retainer nut 380. FIG. 19B is an enlargement of the contact region between sealing projection 332 and angled surface 210.

It will be appreciated that the body of the female coupling member of FIG. 19 is according to a design of the prior art (see, e.g. U.S. Pat. No. 6,575,430 to Robert E. Smith III). Thus, a crown seal 320 according to the present invention may be retrofitted to such a female coupling member by simply replacing the prior art crown seal—i.e. a crown seal having one or more circumferential O-ring seals or radial sealing projections—and, optionally, the retainer nut.

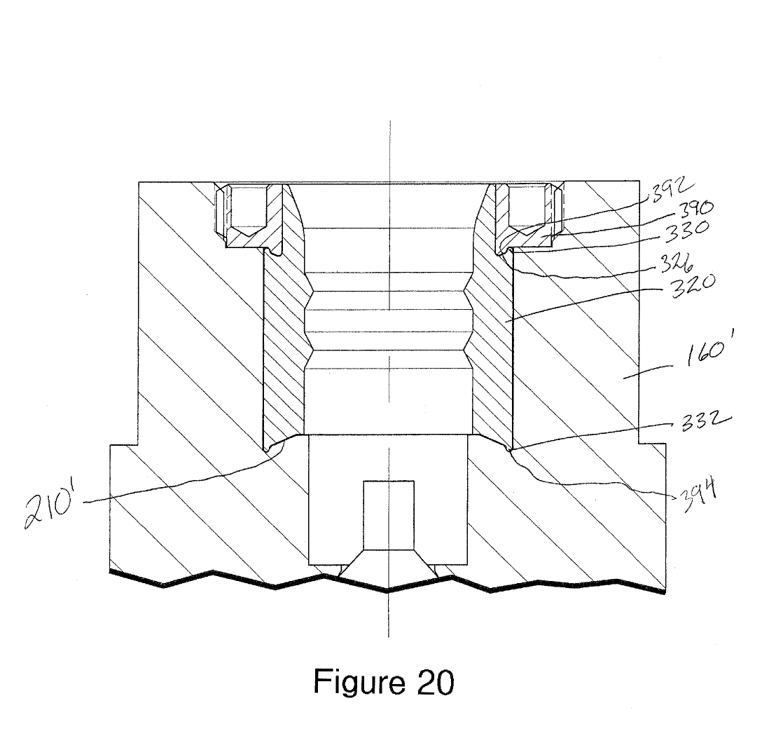

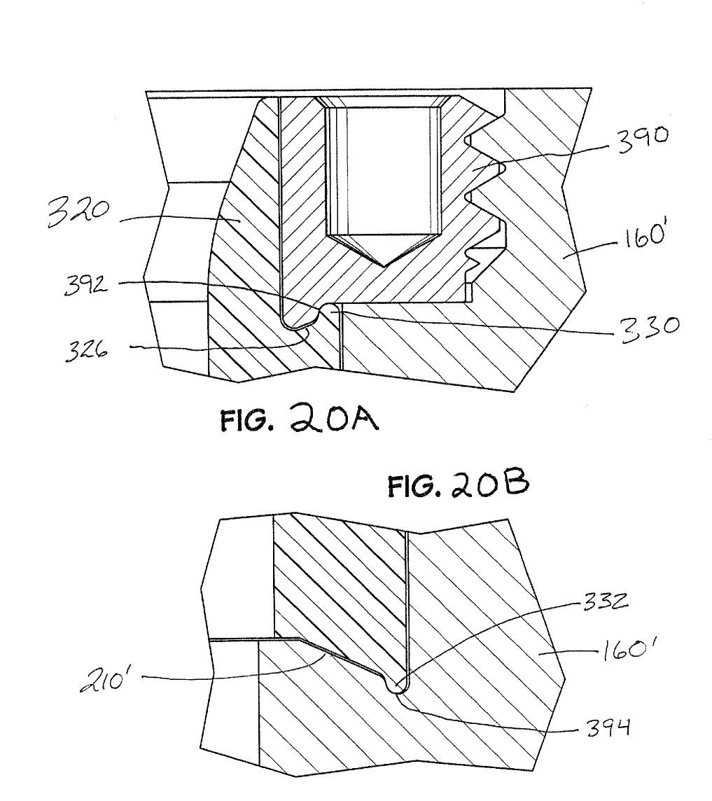

FIG. 20 shows a female coupling member of the type illustrated in FIG. 8—i.e., a female coupling member having no seal cartridge, seal retainer or metal C-seal. In this embodiment, the body of the female member is modified to accommodate axial sealing projection 332. As shown in detail in FIG. 20B, groove 394 at the outer limit of angled shoulder 210′ is sized and spaced to fit axial sealing projection 332.

Retainer nut 390 may also be modified to accommodate axial sealing projection 330 on crown seal 320. As shown in FIG. 20A, retainer nut 390 may be provided with contoured angled surface 392 for contacting axial sealing projection 330 and angled shoulder 326 on seal 320. As shown in detail in FIG. 20B, Groove 394 and/or contoured angled surface 392 may increase the sealing effectiveness of axial sealing projections 330 and 332 of crown seal 320 by providing a larger area of contact between the body of female member 160′ and/or retainer nut 390 and the axial sealing projections 330 and 332.

Although the invention has been described in detail with reference to certain preferred embodiments, variations and modifications exist within the scope and spirit of the invention as described and defined in the following claims.

What is claimed is:

1. A seal for a female hydraulic coupling member comprising:
a generally cylindrical body having a central axial bore;
a first larger outer diameter having a first larger axial dimension;
a second smaller diameter having a second smaller axial dimension;
a first angled surface joining the first outer diameter and the second smaller diameter;
an opposing second angled surface joining the first outer diameter and the second smaller diameter;
a first protrusion having a generally circular cross section at the juncture of the first angled surface and the first outer diameter;
a second protrusion having a generally circular cross section at the juncture of the second angled surface and the first outer diameter.

2. A seal as recited in claim 1 further comprising at least one sealing protrusion having a generally triangular cross section on the interior surface of the central axial bore.

3. A seal as recited in claim 1 further comprising a plurality of sealing protrusions having a generally triangular cross section on the interior surface of the central axial bore.

4. A seal as recited in claim 1 further comprising a bore liner extension extending from at least one end of the seal.

5. A seal as recited in claim 4 wherein at least a portion of the bore liner extension has a tapered inside diameter.

6. A seal as recited in claim 1 wherein the seal is a molded polymer.

7. A seal as recited in claim 1 wherein the seal is machined from an engineering plastic.

8. A seal as recited in claim 7 wherein the engineering plastic is selected from the group consisting of polyetheretherketone, polyoxymethylene and tetrafluoroethylene.

9. A seal for a female hydraulic coupling member comprising:
a generally cylindrical body having a central axial bore;
a first larger outer diameter having a first larger axial dimension;
a second smaller diameter having a second smaller axial dimension;
a first angled surface joining the first outer diameter and the second smaller diameter;
an opposing second angled surface joining the first outer diameter and the second smaller diameter;
a first axial protrusion having a generally semicircular cross section at the juncture of the first angled surface and the first outer diameter;
a second axial protrusion having a generally semicircular cross section at the juncture of the second angled surface and the first outer diameter.

10. A seal as recited in claim 9 further comprising at least one sealing protrusion having a generally triangular cross section on the interior surface of the central axial bore.

11. A seal as recited in claim 9 further comprising a plurality of sealing protrusions having a generally triangular cross section on the interior surface of the central axial bore.

12. A seal as recited in claim 9 further comprising a bore liner extension extending from at least one end of the seal.

13. A seal as recited in claim 12 wherein at least a portion of the bore liner extension has a tapered inside diameter.

14. A seal as recited in claim 9 wherein the seal is a molded polymer.

15. A seal as recited in claim 9 wherein the seal is machined from an engineering plastic.

16. A seal as recited in claim 15 wherein the engineering plastic is selected from the group consisting of polyetheretherketone, polyoxymethylene and tetrafluoroethylene.

17. A female hydraulic coupling member comprising:
a seal as recited in claim 1;
a body having a central axial bore with a stepped internal diameter;
an angled shoulder within the central axial bore connecting a first bore section having a first, larger internal diameter and a second bore section having a second, smaller internal diameter;
a groove in the body proximate the juncture of the angled shoulder and the first bore section sized and spaced such that the first protrusion on the seal fits within the groove when the seal is fully seated in the coupling member.

18. A female hydraulic coupling member as recited in claim 17 further comprising a contour in the wall of the first bore section sized and spaced to fit the second protrusion on the seal when the seal is fully seated in the coupling member.

19. A female hydraulic coupling member comprising:
a seal as recited in claim 1;
a body having a central axial bore with a stepped internal diameter;
a seal retainer which fits within the central axial bore of the body and which has a central axial bore comprising a first bore section having a first, larger internal diameter and a second bore section having a second, smaller internal diameter with an angled shoulder connecting the first section and the second section;
a groove in the seal retainer proximate the juncture of the angled shoulder and the first bore section sized and spaced such that the first protrusion on the seal fits within the groove when the seal is fully seated in the seal retainer.

20. A female hydraulic coupling member as recited in claim 19 further comprising a contour in the wall of the first bore section sized and spaced to fit the second protrusion on the seal when the seal is fully seated in the seal retainer.

21. A female hydraulic coupling member comprising:
a seal as recited in claim 1;
a body having a central axial bore with a stepped internal diameter;
a seal cartridge comprising a seal carrier which fits within the central axial bore of the body and which has a central axial bore comprising a first bore section having a first, larger internal diameter and a second bore section having a second, smaller internal diameter with an angled shoulder connecting the first section and the second section;
a groove in the seal carrier proximate the juncture of the angled shoulder and the first bore section sized and spaced such that the first protrusion on the seal fits within the groove when the seal is fully seated in the seal carrier.

22. A female hydraulic coupling member as recited in claim 21 further comprising a contour in the wall of the first bore section sized and spaced to fit the second protrusion on the seal when the seal is fully seated in the seal carrier.

23. A female hydraulic coupling member comprising:
a seal as recited in claim 9;
a body having a central axial bore with a stepped internal diameter;
an angled shoulder within the central axial bore connecting a first bore section having a first, larger internal diameter and a second bore section having a second, smaller internal diameter;
a groove in the body proximate the juncture of the angled shoulder and the first bore section sized and spaced such that the first axial protrusion on the seal fits within the groove when the seal is fully seated in the coupling member.

24. A female hydraulic coupling member as recited in claim 23 further comprising a retainer nut having a contoured angled surface sized and spaced to fit at least a portion of the second axial protrusion on the seal when the retainer nut, seal and seal retainer are inserted in the central axial bore of the female member.

25. A female hydraulic coupling member comprising:
a seal as recited in claim 9;
a body having a central axial bore with a stepped internal diameter;
a seal retainer which fits within the central axial bore of the body and which has a central axial bore comprising a first bore section having a first, larger internal diameter and a second bore section having a second, smaller internal diameter with an angled shoulder connecting the first section and the second section;
a groove in the seal retainer proximate the juncture of the angled shoulder and the first bore section sized and spaced such that the first axial protrusion on the seal fits within the groove when the seal is fully seated in the seal retainer.

26. A female hydraulic coupling member as recited in claim 25 further comprising a retainer nut having a contoured angled surface sized and spaced to fit at least a portion of the second axial protrusion on the seal when the retainer nut, seal and seal retainer are inserted in the central axial bore of the female member.

27. A female hydraulic coupling member comprising:
a seal as recited in claim 9;
a body having a central axial bore with a stepped internal diameter;
a seal cartridge comprising a seal carrier which fits within the central axial bore of the body and which has a central axial bore comprising a first bore section having a first, larger internal diameter and a second bore section having a second, smaller internal diameter with an angled shoulder connecting the first section and the second section;
a groove in the seal carrier proximate the juncture of the angled shoulder and the first bore section sized and spaced such that the first axial protrusion on the seal fits within the groove when the seal is fully seated in the seal carrier.

28. A female hydraulic coupling member as recited in claim 27 wherein the seal cartridge comprises an externally threaded shell having a stepped internal bore comprising first section having a first, smaller internal diameter and a second section having a second, larger internal diameter and an angled shoulder connecting the first section and the second section which angled shoulder has a contoured surface sized and spaced to fit at least a portion of the second axial protrusion on the seal when the seal and seal carrier are inserted in the shell.
